(19) United States
(12) Patent Application Publication
(10) Pub. No.: US 2026/0234855 A1
(43) Pub. Date: Aug. 13, 2026

(54) SEALING SYSTEM FOR A WASHING MACHINE APPLIANCE

(71) Applicant: Haier US Appliance Solutions, Inc., Wilmington, DE (US)

(72) Inventor: Tanner Davis Gunn, Louisville, KY (US)

(21) Appl. No.: 19/052,432

(22) Filed: Feb. 13, 2025

(51) Int. Cl. D06F 37/26; D06F 23/02; D06F 39/14; F16J 15/3284

(52) U.S. Cl. CPC D06F 37/266; D06F 23/02; D06F 39/14; F16J 15/3284

(57) ABSTRACT

A washing machine appliance includes a cabinet, a door, a subwasher assembly, and seal. The subwasher assembly includes a front wall adjacent to the door. A first lip and a second lip extend from the front wall and form a perimeter corresponding to the opening to the wash chamber. The seal is attachable to the first lip and the second lip. A duct is formed between the seal and the front wall between the first lip and the second lip. The duct extends substantially along the perimeter corresponding to the opening. The seal includes one or more folds in which a cavity is formed at the one or more folds. The seal includes a plurality of vent openings fluidly communicating the duct to the cavity. A passage extends from the cavity to the opening to the wash chamber.

### FIELD OF THE INVENTION

The present subject matter relates generally to washing machine appliances, and more particularly to sealing systems for washing machine appliances.

### BACKGROUND OF THE INVENTION

Washing machine appliances, such as laundry machines, generally seals to keep liquid and moisture in desired areas (e.g., in the wash chamber) and to keep other areas dry. Improper and insufficient sealing can allow liquid and moisture to propagate, which can facilitate deterioration, such as undesired growth of fungi, bacteria, or other agents, or promote corrosion.

For front-load washing machines, a gasket at the laundry loading door provides a seal between a subwasher assembly including the wash chamber and the laundry loading door. The door gasket may include slack, creases, or folds at which fluid can accumulate, which can facilitate deterioration. Slacks, creases, or folds can inhibit air flow between the folds at the gasket, which can also facilitate deterioration. Furthermore, folds at the gasket can inhibit removing liquid and moisture through air flow promotion along the gasket. Additionally, or alternatively, fluid at the door gasket can leave residue or physical appearances that are undesired to the user.

Accordingly, washing machine appliances addressing one or more of the aforementioned issues would be advantageous and beneficial. Furthermore, a front-load washing machine addressing one or more of the aforementioned issues would be advantageous and beneficial.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a front load washing machine appliance. The washing machine includes a cabinet, a door, a subwasher assembly, and seal. The cabinet forms an interior and the door is attachable to the cabinet. The door corresponds to an opening to a wash chamber and permits selective access to the opening and the wash chamber. The subwasher assembly is disposable in the interior of the cabinet and includes the wash chamber. The subwasher assembly includes a front wall adjacent to the door. A first lip and a second lip extend from the front wall and form a perimeter corresponding to the opening to the wash chamber. The seal is attachable to the first lip and the second lip. A duct is formed between the seal and the front wall between the first lip and the second lip. The duct extends substantially along the perimeter corresponding to the opening. The seal includes one or more folds in which a cavity is formed at the one or more folds. The seal includes a plurality of vent openings fluidly communicating the duct to the cavity. A passage extends from the cavity to the opening to the wash chamber.

An aspect of the present disclosure is directed to a washing machine appliance. The washing machine appliance includes a cabinet forming an interior. A door is attachable to the cabinet and corresponds to an opening to a wash chamber. The door permits selective access to the opening and the wash chamber. A subwasher assembly is disposable in the interior of the cabinet. The subwasher includes the wash chamber. The subwasher assembly includes a front wall adjacent to the door. A first lip and a second lip extend from the front wall and form a perimeter corresponding to the opening to the wash chamber. A seal is attachable to the first lip and the second lip. A duct is formed between the seal and the front wall between the first lip and the second lip. The duct extends substantially along the perimeter corresponding to the opening. The seal includes one or more folds. A cavity is formed at the one or more folds. The seal includes a plurality of vent openings fluidly communicating the duct to the cavity. A passage extends from the cavity to the opening to the wash chamber. The seal includes a manifold forming an airflow passage extending in fluid communication with the duct. The airflow passage extends from an inlet opening through which air is received into the airflow passage and an outlet opening through which air egresses to the duct.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary embodiment of a front load washing machine appliance in accordance with aspects of the present disclosure.

FIG. 2 provides a cross section view of the exemplary washing machine appliance of FIG. 1.

FIG. 3 provides a cross section view of an embodiment of a front load washing machine appliance in accordance with aspects of the present disclosure.

FIG. 4 provides a cross section view of an embodiment of the front load washing machine appliance in accordance with aspects of the present disclosure.

FIG. 5 provides a detailed cross section view of an exemplary embodiment of a sealing system for a washing machine appliance in accordance with aspects of the present disclosure.

FIG. 6 provides a detailed cross section view of an exemplary embodiment of the sealing system for a washing machine appliance in accordance with aspects of the present disclosure.

FIG. 7 provides a perspective cross section view of an exemplary embodiment of the sealing system for a washing machine appliance in accordance with aspects of the present disclosure.

FIG. 8 provides a perspective view of an exemplary embodiment of a front load washing machine appliance including a sealing system in accordance with aspects of the present disclosure.

FIG. 9 provides a front planar section view of an exemplary embodiment of a front load washing machine appliance including a sealing system in accordance with aspects of the present disclosure.

FIG. 10 provides a front planar view of an exemplary embodiment of a front load washing machine appliance including a sealing system in accordance with aspects of the present disclosure.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

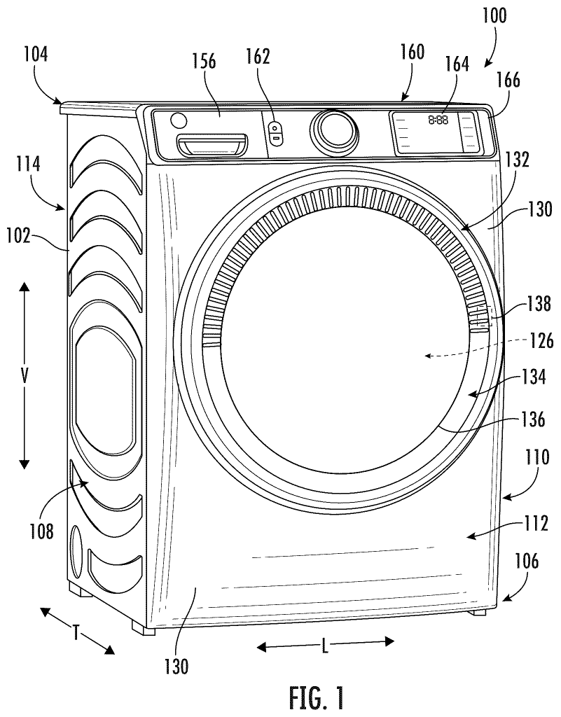

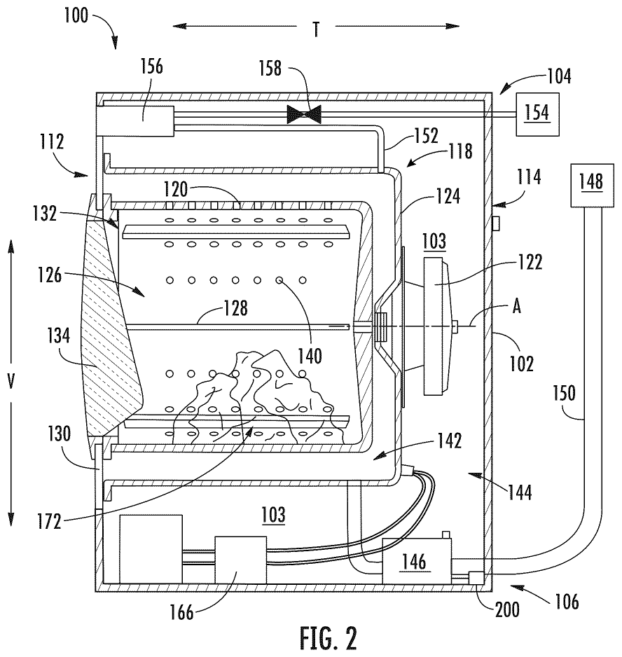

Referring now to the figures, an exemplary laundry appliance that may be used to implement aspects of the present subject matter will be described. Specifically, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined.

According to exemplary embodiments, washing machine appliance 100 includes a cabinet 102 that is generally configured for containing and/or supporting various components of washing machine appliance 100 and which may also define one or more internal chambers or compartments of washing machine appliance 100. In this regard, as used herein, the terms “cabinet,” “housing,” and the like are generally intended to refer to an outer frame or support structure for washing machine appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of washing machine appliance 100. By contrast, cabinet 102 may enclose some or all portions of an interior 103 of cabinet 102. It should be appreciated that cabinet 102 may have any suitable size, shape, and configuration while remaining within the scope of the present subject matter.

As illustrated, cabinet 102 generally includes a plurality of walls forming the interior 103. The cabinet 102 generally extends between a top wall 104 and a bottom wall 106 along the vertical direction V, between a first side wall 108 (e.g., the left side when viewed from the front as in FIG. 1) and a second side wall 110 (e.g., the right side when viewed from the front as in FIG. 1) along the lateral direction L, and between a front end 112 and a rear end 114 along the transverse direction T. It should be appreciated that ends 112, 114 may form walls that may be included as portions of other structures or subassemblies, such as subwasher 118. In general, terms such as “left,” “right,” “front,” “rear,” “top,” or “bottom” are used with reference to the perspective of a user accessing washing machine appliance 100.

Referring to FIG. 2, a wash basket 120 is rotatably mounted within cabinet 102 such that it is rotatable about an axis of rotation W. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

According to exemplary embodiments, wash tub 124 may be generally suspended within cabinet 102 by one or more suspension assemblies. In this regard, wash tub 124, wash basket 120, motor 122, and other components of washing machine appliance 100 may be referred to generally herein as a subwasher 118. The subwasher 118 may be separately assembled and installed into cabinet 102, such as through an open front 112 of the cabinet 102 into interior 103.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments. Washing machine appliance 100 may further include a latch assembly 138 (see FIG. 1) that is mounted to cabinet 102 and/or door 134 for selectively locking door 134 in the closed position and/or confirming that the door 134 is in the closed position. Latch assembly 138 may be desirable, for example, to ensure only secured access to wash chamber 126 or to otherwise ensure and verify that door 134 is closed during certain operating cycles or events.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

Washing machine appliance 100 may further include a wash fluid dispenser that is generally configured for dispensing a flow of water, wash fluid, etc. into wash tub 124. For example, a spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present subject matter.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

During operation of washing machine appliance 100, laundry items 172 are loaded into wash basket 120 through opening 132, and washing operation is initiated through operator manipulation of one or more input selectors or using a remote device (see below). Wash tub 124 is filled with water, detergent, and/or other fluid additives, e.g., via spout 152 and/or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items 172 in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

In certain embodiments, control panel 160, with at least one input selector 162, extends from front 112. Control panel 160 and input selector 162 collectively form a user interface input for operator selection of machine cycles and features. A display 164 of control panel 160 indicates selected features, operation mode, a countdown timer, or other items of interest to appliance users regarding operation. Operation of washing machine appliance 100 may be controlled by a controller 166 connected (e.g., electrically coupled) to control panel 160 for user manipulation to select washing machine cycles and features. In response to user manipulation of control panel 160, controller 166 operates the various components of washing machine appliance 100 to execute selected machine cycles and features.

Controller 166 may include a memory (e.g., non-transitive media) and microprocessor, such as a general or special purpose microprocessor operable to execute programming instructions or micro-control code associated with a selected machine cycles and features (e.g., as part of a washing operation). The memory may represent random access memory such as DRAM, or read only memory such as ROM or FLASH. In certain embodiments, the processor executes programming instructions stored in memory. The memory may be a separate component from the processor or may be included onboard within the processor. Alternatively, controller 166 may be constructed without using a microprocessor (e.g., using a combination of discrete analog or digital logic circuitry, such as switches, amplifiers, integrators, comparators, flip-flops, AND gates, and the like) to perform control functionality instead of relying upon software. Control panel 160 and other components of washing machine appliance 100 (e.g., one or more sensors, such as a pressure sensor mounted to tub 124) may be in communication with controller 166 via one or more signal lines or shared communication busses.

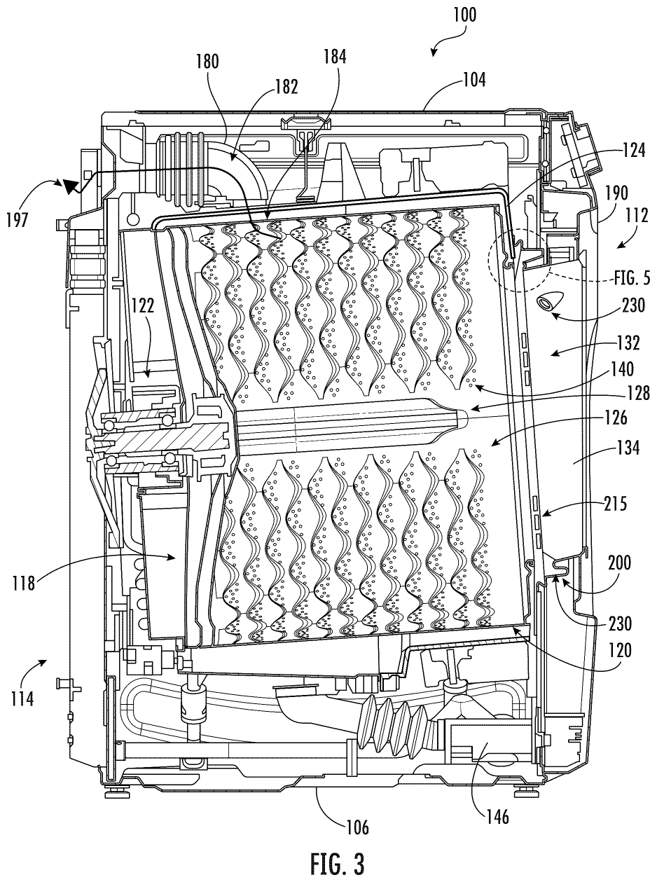

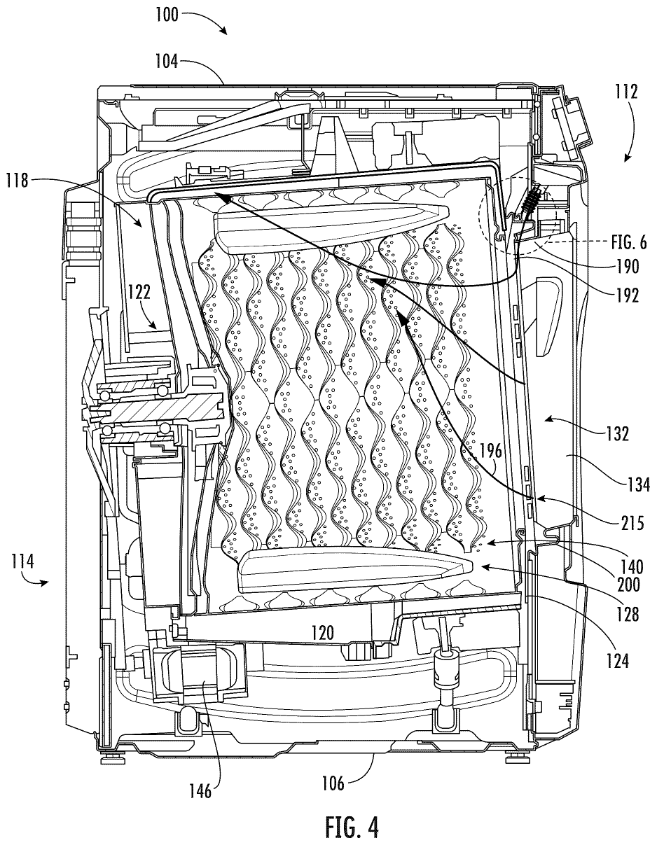

FIG. 2 depicts a section view of washing machine appliance 100 that is a front load washing machine. FIGS. 3-4 depict section views of the washing machine appliance 100 illustrating air flow paths across a sealing system 190 according to aspects of the present disclosure. Cabinet 102 defines an interior 103 at which operable components of the appliance are generally positioned, such as the subwasher 118 extendable into the cabinet 102 through the front end 112. Door 134 is attachable to cabinet 102 and configured to seal a laundry loading opening 132 to the wash chamber 126. A gasket, such as seal 200, is positioned between the door 134 and the subwasher 118, such as the wash tub 124, to seal liquid within the wash chamber 126 and prevent egress to the interior 103 or through the door 134.

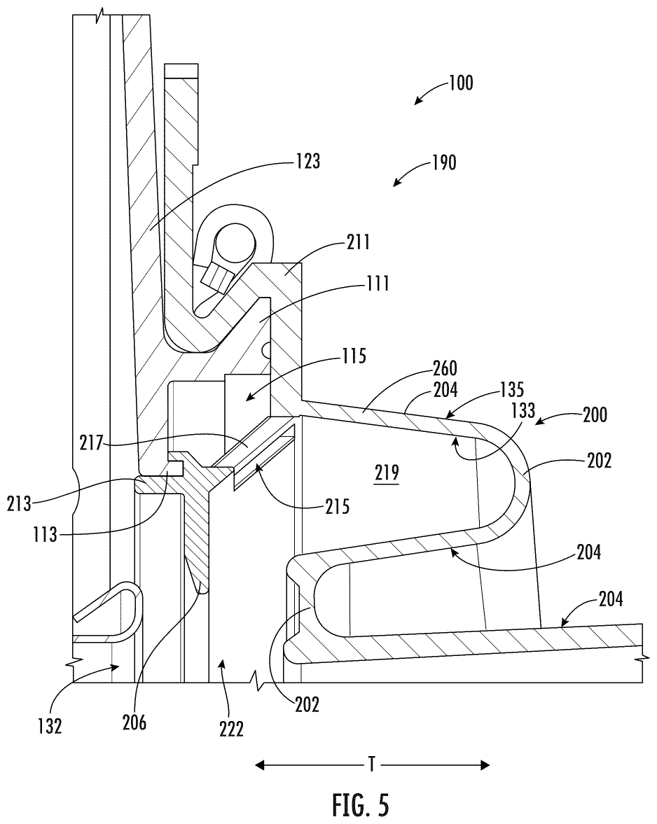

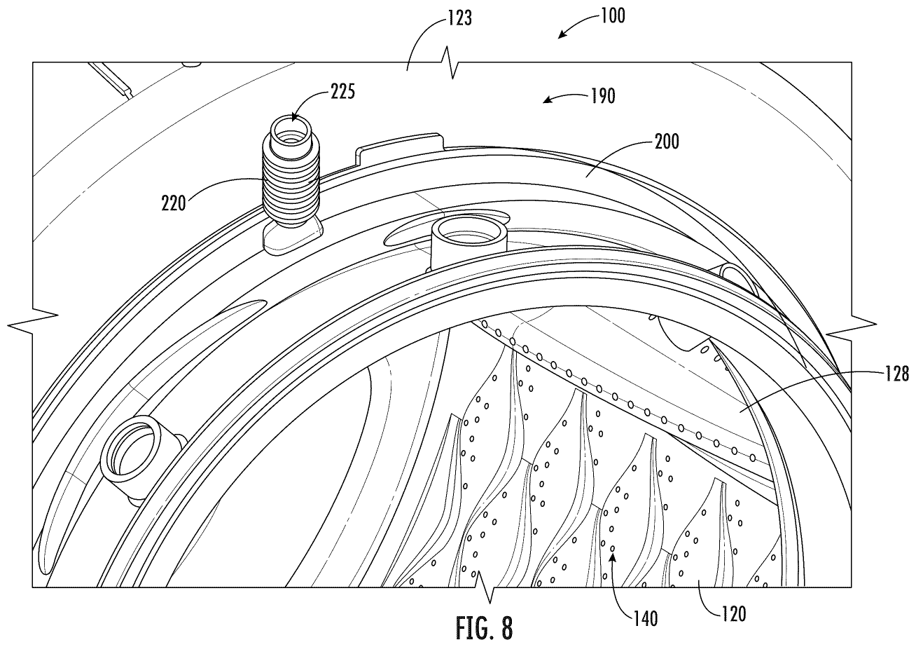

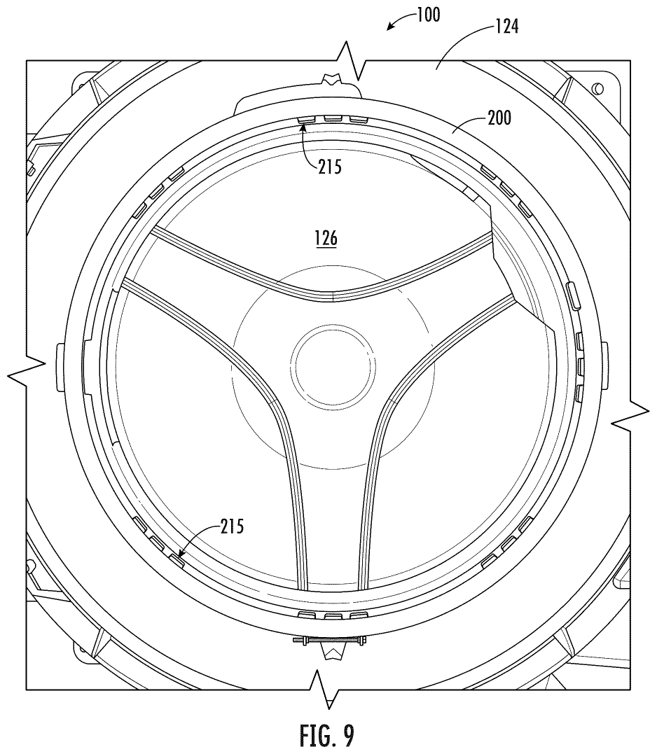

FIGS. 5-10 provide detailed views of an embodiment of the sealing system 190. The sealing system 190 includes a seal 200 having an outer surface 135 at which the door 134 (FIGS. 1-4) is positioned. The subwasher 118 includes a front wall 123, such as at the wash tub 124 (FIGS. 2-4), at which the seal 200 couples to the subwasher 118. A first lip 111 and a second lip 113 extend from the front wall 123 along the transverse direction T toward the seal 200 (e.g., extending outward toward the door 134). Lip 111, 113 extending from the front wall 123 form a duct 115 between the front wall 123 and the gasket 200. Lip 111, 113 extend substantially or fully to form a perimeter, such as substantially or fully circumferentially or annularly corresponding to door 134 or opening 132. The duct 115 forms an air flow path around the perimeter of the opening 132 to the wash basket 120 in the wash tub 124.

Seal 200 includes a flexible, compliant body 210 having one or more bends, creases, or folds 202 connecting portions 204 extending along first and second directions along the transverse direction T (i.e., extending toward and away from the front wall 123). The body 210 forms a cavity 219 between the portions 204 and one or more folds 202. For instance, portions 204 and fold 202 may form a substantially U-shaped or V-shaped bend at which cavity 219 is formed. The body 210 includes a first mating portion 211 corresponding to the first lip 111 and configured to fit around the lip 111. The body 210 includes a second mating portion 213 corresponding to the second lip 213 and configured to fit around the lip 113. A member 217 connects the first mating portion 211 to the second mating portion 213. A plurality of vent openings 215 is formed between the mating portions 211, 213. The vent openings 215 are positioned between duct 115 and cavity 219. Member 217 separates vent openings 215 from one another, such as to form a plurality of discrete vent openings 215. Air is permitted to flow through duct 115 around the perimeter of the opening 132 to the wash basket 120, and from duct 115 through vent openings 215 to cavity 219 and into the subwasher 118. For instance, vent openings 215 may be positioned in circumferential arrangement around the perimeter of the opening 132 at the wash tub 124. The vent openings 215 may be oriented and spaced such as depicted and described herein to promote maximum airflow and to push water droplets down toward a drain 230 at the seal 200.

In various embodiments, lips 111, 113 extend from front wall 123 for attaching the seal 200 at corresponding mating portions 211, 213. Lips 111, 113 and front wall 123 may form, at least in part, a contoured half (e.g., U-shaped, V-shaped). Corresponding mating portions 211, 213 may form, at least in part, a corresponding contoured half, such as to form the duct 115 as a U-shaped, V-shaped, round or oval, etc. plenum forming a sealed duct.

In various embodiments, vent openings 215 are oriented to direct air from duct 115 into slack, creases, or folds at the seal 200, such as toward folds 202 and portions 204 connected at fold 202. In some embodiments, first lip 111 and corresponding first mating portion 211 extend further outward along the transverse direction T than second lip 113 and second mating portion 213. Member 217 extends along an angle (e.g., approximately 45 degrees, or +/−25 degrees) between first mating portion 211 and second mating portion 213. Vent openings 215 are substantially oriented correspondingly along the angle between duct 115 and cavity 219, such as may promote fluid communication and flow of air along internal surfaces 133 and cavities 219 of the seal 200 to dry the seal 200.

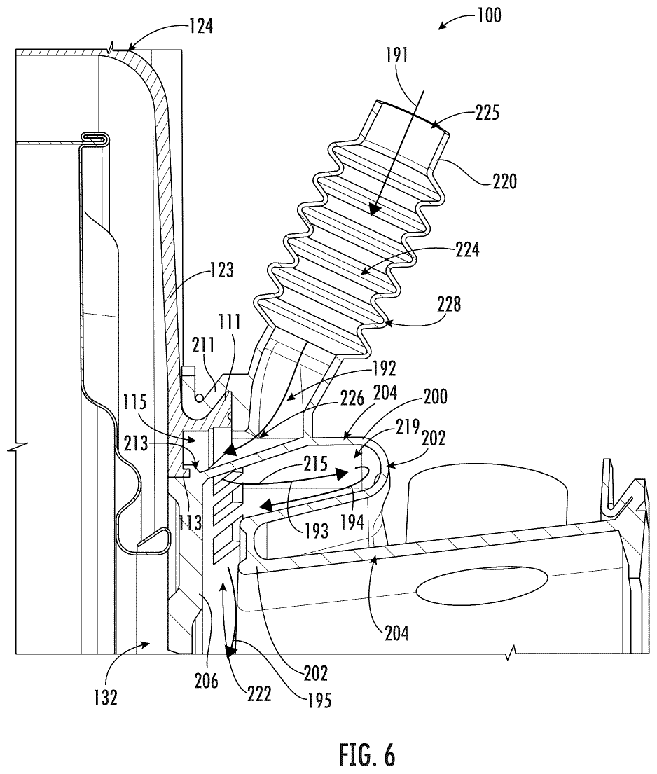

Referring to FIGS. 5-7, in various embodiments, the seal 200 forms a passage 222 extending between a bend 202 and a wall 206 extending from the second mating portion 213. The passage 222 is in fluid communication with the cavity 219, such as to receive a flow of air through the passage 222 (depicted schematically via arrow 195 in FIG. 6) from the vent opening 215. The passage 222 may form a channel through which air is permitted to flow from the vent opening 215 and through cavity 219 to opening 132 to wash basket 120.

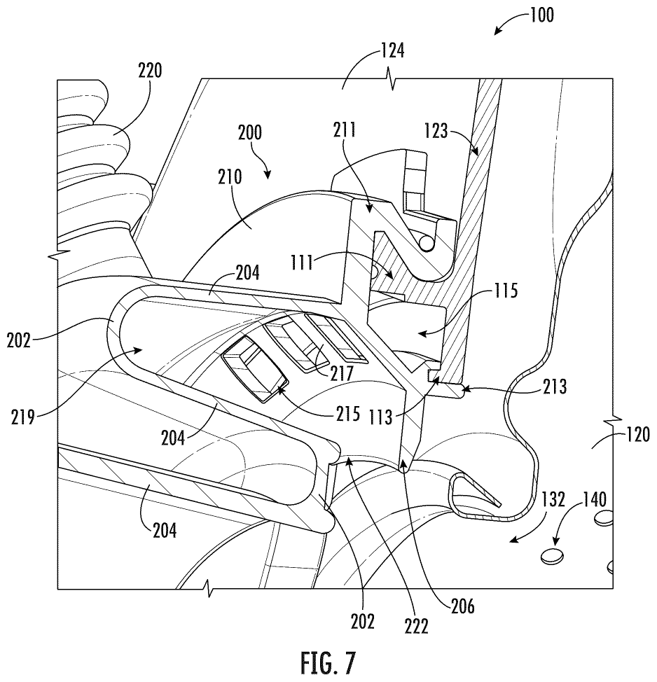

Referring to FIGS. 6-7, in various embodiments, seal 200 includes a manifold or tube 220 forming an airflow passage 224 extending in fluid communication with duct 115. In some embodiments, tube 220 includes an inlet opening 225 configured to receive a flow of air into the airflow passage 224 (such as depicted schematically via arrow 191), and an outlet opening 226 configured to egress the flow of air from the airflow passage 224 to the duct 115 (such as depicted schematically via arrow 192). In still some embodiments, the outlet opening 226 is positioned circumferentially adjacent to a vent opening 215, or between a pair of vent openings 215.

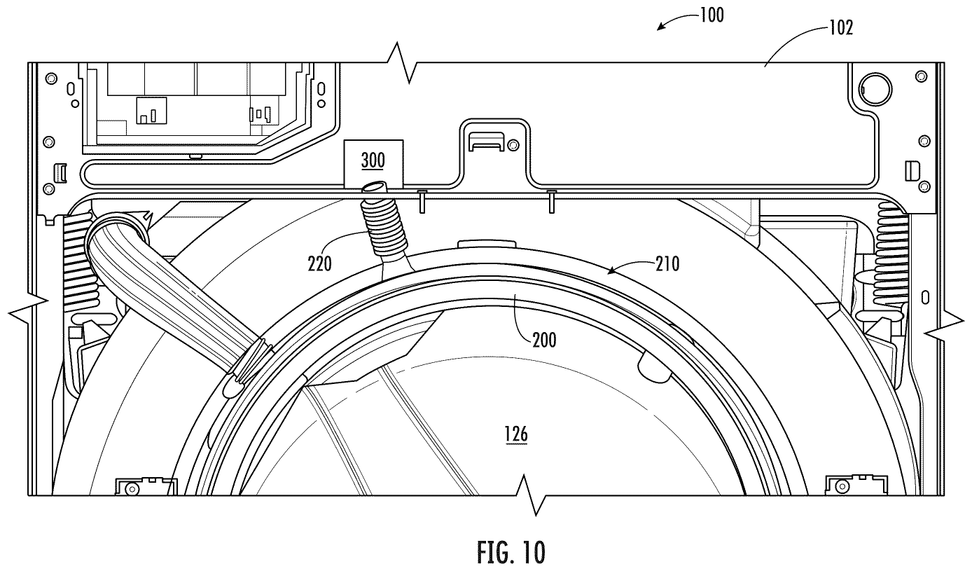

In some embodiments, the manifold or tube 220 may include a springing structure or bellows 228 forming an outer wall of the airflow passage 224. The bellows 228 may facilitate attaching a hose or conduit to the tube 220, or an airflow generation device 300, such as a fan or pump, to the inlet opening 225, such as depicted in FIG. 10. Bellows 228 may additionally, or alternatively, provide bending, flexing, and compliance, such as to maintain attachment between the airflow generation device 300 and the seal 200 while the appliance 100 is running (e.g., wash cycles, spin cycles, etc.). In still some embodiments, the tube 220 is positioned at a top half relative to the subwasher 118, such as to prevent ingress of water into the airflow passage 224 while the appliance 100 is operating.

Various embodiments of the seal 200 include features formed or molded as a unitary, monolithic, integral component. For instance, portions 204, folds 202, member 217, vent openings 215, cavity 219, passage 222, and tube 220 may be integrally formed or molded as an integral component of the seal body 210.

Referring to FIGS. 3-10, in an exemplary embodiment of operation of the sealing system 190, the airflow generation device 300 urges a flow of air 191 through the airflow passage 224 and into duct 115. Vent openings 215 permit the flow of air to egress from the duct 115 into fluid communication with internal surfaces 133 at the cavity 219, such as depicted schematically via arrows 193, 194. Passage 222, extending in fluid communication from the cavity 219 toward the laundry opening 132, permits flow of air from the cavity 219 to the wash chamber 126, such as depicted via arrow 195. Referring to FIG. 4, airflow from the vent openings 215 and passage 222, depicted schematically via arrows 196, is pulled through to an air outlet opening 184, such as depicted in FIG. 3. Referring to FIG. 3, the subwasher 118 may include the air outlet opening 184 extending fluidly from the wash chamber 126 and through the wash tub 124. An outlet duct 180 forms an outlet flow passage 182 through which a flow of air is permitted to egress to exterior of the appliance 100, such as depicted schematically via arrows 197. In some embodiments, air outlet opening 184 is positioned in a rear portion (e.g., a rear half) of the subwasher 118 along the transverse direction T. However, it should be appreciated that the air outlet opening 184 may be positioned along one or more portions along the transverse direction T, such as at a forward half or middle portion (e.g., 50% span +/−25% along the transverse direction T).

Embodiments of the appliance 100 may include the sealing system 190 including the seal 200 and the duct 115 formed between the front wall 123 and the seal 200. Various embodiments may further include the tube 220 and air flow generation device 300 to induce airflow through the duct 115, cavity 219, and passage 222. The appliance 100 and sealing system 190 may include the airflow vent opening 184 to egress air flow from the appliance 100 and seal 200. Embodiments provided herein may advantageously and beneficially promote airflow across internal surfaces, creases, and folds at the seal, or between the seal and mating surfaces at the subwasher or door, such as may inhibit migration of liquid and moisture between the subwasher 118 and door 132, and inhibit deterioration and corrosion of the appliance and inhibit growth of undesired fungi, bacteria, or other agents.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A front load washing machine appliance comprising:
a cabinet forming an interior;
a door attachable to the cabinet, the door corresponding to an opening to a wash chamber, the door permitting selective access to the opening and the wash chamber;
a subwasher assembly disposable in the interior of the cabinet, the subwasher comprising the wash chamber, the subwasher assembly comprising a front wall adjacent to the door, wherein a first lip and a second lip extend from the front wall and form a perimeter corresponding to the opening to the wash chamber; and
a seal attachable to the first lip and the second lip, wherein a duct is formed between the seal and the front wall between the first lip and the second lip, the duct extending substantially along the perimeter corresponding to the opening, wherein the seal comprises one or more folds, wherein a cavity is formed at the one or more folds, and wherein the seal comprises a plurality of vent openings, the plurality of vent openings fluidly communicating the duct to the cavity, and wherein a passage extends from the cavity to the opening to the wash chamber.

2. The front load washing machine appliance of claim 1, wherein the passage extends substantially radially from the cavity toward the opening to the wash chamber.

3. The front load washing machine appliance of claim 1, wherein the seal comprises a first mating portion corresponding to the first lip, and wherein the seal comprises a second mating portion corresponding to the second lip.

4. The front load washing machine appliance of claim 3, wherein the seal, the first lip, and the second lip form the duct as a substantially U-shaped or V-shaped plenum.

5. The front load washing machine appliance of claim 1, wherein the first lip extends along a transverse direction toward the seal greater than the second lip extending along the transverse direction toward the seal.

6. The front load washing machine appliance of claim 1, wherein the plurality of vent openings are oriented to direct air from the duct toward the one or more folds at the seal.

7. The front load washing machine appliance of claim 6, wherein the seal comprises a member extending from a first mating portion to a second mating portion, wherein the member separates the plurality of vent openings into discrete vent openings.

8. The front load washing machine appliance of claim 7, wherein the member extends along an angle between the first mating portion and the second mating portion, wherein the angle is between approximately 20 degrees and approximately 70 degrees.

9. The front load washing machine appliance of claim 1, the seal comprising:
a manifold forming an airflow passage extending in fluid communication with the duct, wherein the airflow passage extends from an inlet opening through which air is received into the airflow passage and an outlet opening through which air egresses to the duct.

10. The front load washing machine appliance of claim 9, wherein the outlet opening is positioned circumferentially adjacent to the plurality of vent openings.

11. The front load washing machine appliance of claim 9, wherein the manifold comprises a springing structure forming an outer wall of the airflow passage.

12. The front load washing machine appliance of claim 9, wherein the seal comprises a seal body, the seal comprising a manifold, a member extending between a first mating portion and a second mating portion, and a plurality of vent openings positioned in circumferential arrangement and separated by the member, and wherein the seal body comprises a unitary, monolithic, integral component.

13. The front load washing machine appliance of claim 9, comprising:
an airflow generation device, the airflow generation device coupled to the manifold to urge a flow of air through the inlet opening to the airflow passage at the manifold and through the outlet opening to the duct formed between the front wall and the seal.

14. The front load washing machine appliance of claim 13, wherein the subwasher comprises an air outlet opening extending fluidly from the wash chamber to an exterior of the appliance.

15. A washing machine appliance, comprising:
a cabinet forming an interior;
a door attachable to the cabinet, the door corresponding to an opening to a wash chamber, the door permitting selective access to the opening and the wash chamber;
a subwasher assembly disposable in the interior of the cabinet, the subwasher comprising the wash chamber, the subwasher assembly comprising a front wall adjacent to the door, wherein a first lip and a second lip extend from the front wall and form a perimeter corresponding to the opening to the wash chamber; and
a seal attachable to the first lip and the second lip, wherein a duct is formed between the seal and the front wall between the first lip and the second lip, the duct extending substantially along the perimeter corresponding to the opening, wherein the seal comprises one or more folds, wherein a cavity is formed at the one or more folds, and wherein the seal comprises a plurality of vent openings, the plurality of vent openings fluidly communicating the duct to the cavity, and wherein a passage extends from the cavity to the opening to the wash chamber, the seal comprising a manifold forming an airflow passage extending in fluid communication with the duct, wherein the airflow passage extends from an inlet opening through which air is received into the airflow passage and an outlet opening through which air egresses to the duct.

16. The washing machine appliance of claim 15, wherein the outlet opening is positioned circumferentially adjacent to the plurality of vent openings.

17. The washing machine appliance of claim 15, wherein the manifold comprises a springing structure forming an outer wall of the airflow passage.

18. The washing machine appliance of claim 15, wherein the seal comprises a seal body, the seal comprising the manifold, a member extending between a first mating portion and a second mating portion, and a plurality of vent openings positioned in circumferential arrangement and separated by the member, and wherein the seal body comprises a unitary, monolithic, integral component.

19. The washing machine appliance of claim 15, comprising:
an airflow generation device, the airflow generation device coupled to the manifold to urge a flow of air through the inlet opening to the airflow passage at the manifold and through the outlet opening to the duct formed between the front wall and the seal.

20. The washing machine appliance of claim 19, wherein the subwasher comprises an air outlet opening extending fluidly from the wash chamber to an exterior of the appliance.
